(19) United States
(12) Patent Application Publication
(10) Pub. No.: US 2012/0102018 A1
(43) Pub. Date: Apr. 26, 2012

(54) Ranking Model Adaptation for Domain-Specific Search

(75) Inventors: Linjun Yang, Beijing (CN); Bo Geng, Beijing (CN); Xian-Sheng Hua, Beijing (CN)

(73) Assignee: Microsoft Corporation, Redmond, WA (US)

(21) Appl. No.: 12/911,503

(22) Filed: Oct. 25, 2010

(51) Int. Cl. G06F 15/18; G06F 17/30

(52) U.S. Cl. 707/709; 707/723; 706/12; 707/E17.014; 707/E17.108

(57) ABSTRACT

An adaptation process is described to adapt a ranking model constructed for a broad-based search engine for use with a domain-specific ranking model. An example process identifies a ranking model for use with a broad-based search engine and modifies that ranking model for use with a new (or “target”) domain containing information pertaining to a specific topic.

### BACKGROUND

“Learning to rank” approach enables a ranking model to be automatically constructed for a broad-based search engine based upon training data. The training data represents documents returned to a search query and are labeled by humans according to the relevance with respect to the query. The purpose of the broad-based search engine ranking model is to rank the data from various domains in a way that is similar to rankings in the training data.

Applying ranking models constructed for use with a broad-based search engine to a domain-specific environment may present many obstacles. For example, the broad-based ranking models are typically built upon data retrieved from multiple domains, and can therefore be difficult to adapt for a particular domain with special search intentions. Alternatively, creating a ranking model specific to each of the various specific domains available on the web is both time consuming and computational expensive as the resources required for such an undertaking would be considerable.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In view of the above, this disclosure describes example methods, systems, and computer-readable media for implementing a process to adapt a ranking model constructed for a broad-based search engine for use with a domain-specific ranking model.

In an example implementation, a ranking model utilized in a general search environment is identified. The ranking model is adapted for use in a search environment focusing on a specific segment of online content, for example, a specific topic, media type, or genre of content. Following the modification, a domain-specific ranking model reduces search results to the data from a specific domain that are relevant with respect to the search terms input by the user. The ranking order may be determined with reference to a given numerical score, an ordinal score, or a binary judgment such as “relevant” or “irrelevant”.

A ranking-model adaptation module is used to adapt a ranking model utilized by a general domain for use with a specific domain resulting in an adapted ranking model. For example, a ranking model typically used with a general content search environment may be adapted for use with a search engine utilized to search images on the World Wide Web.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical items.

FIG. 1 is a schematic of an illustrative environment for the adaptation of a broad-based ranking model.

FIG. 2 is a block diagram of an example computing device within the adaptation environment of FIG. 1.

FIG. 3 is a block diagram of an example server within the adaptation environment of FIG. 1.

FIG. 4 is an illustrative an example adaptation process within the adaptation environment of FIG. 1

FIG. 5 is a flow chart of an example use outlining the adaptation process for a ranking model within the adaptation environment of FIG. 1.

FIG. 6 is a flow chart of an example use outlining a domain-specific search within the adaptation environment of FIG. 1.

### DETAILED DESCRIPTION

A method and process to adapt a ranking model constructed for a broad-based search engine for use with a domain-specific ranking model is described. More specifically, an example process identifies a ranking model for use with a broad-based search engine and modifies that ranking model for use with a new (or “target”) domain containing information pertaining to a specific topic. That is, the broad-based ranking model is adapted using training data labeled in the new domain. The adapted ranking model reduces the number of necessary labeled training data in the new domain and, therefore, reduces the computational costs and resources necessary to construct the adapted ranking model. In addition, the adapted ranking model still maintains the precision of the search results.

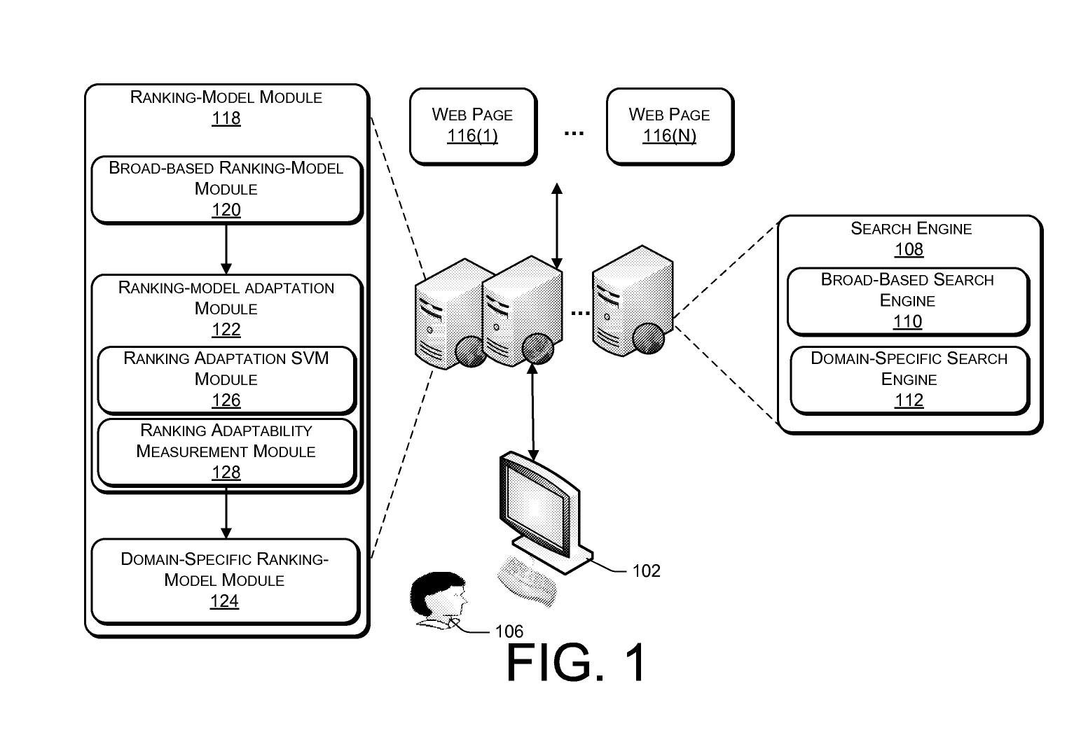

FIG. 1 is a block diagram of an example environment 100, which is used for the adaptation of a broad-based ranking-model. The environment 100 includes an example computing device 102, which may take a variety of forms including, but not limited to, a portable handheld computing device (e.g., a personal digital assistant, a smart phone, a cellular phone), a laptop computer, a desktop computer, a media player, a digital camcorder, an audio recorder, a camera, or any other similar device.

The computing device 102 may connect to one or more networks(s) 104 and is associated with a user 106. The network(s) 104 represent any type of communications network(s), including, but not limited to, wire-based networks (e.g., cable), wireless networks (e.g., cellular, satellite), cellular telecommunications network(s), and IP-based telecommunications network(s) (e.g., Voice over Internet Protocol networks). The network(s) 104 may also include traditional landline or a public switched telephone network (PSTN), or combinations of the foregoing (e.g., Unlicensed Mobile Access or UMA networks, circuit-switched telephone networks or IP-based packet-switch networks).

The computing device 102 enables the user 106 to operate a browser or other client application to interact with a search engine 108. For instance, the user 106 may launch a browser to navigate to the search engine 108 and input a search term or search terms, constituting a user query, into a search engine 108. The user input is received through any of a variety of user input devices, including, but not limited to, a keyboard, a mouse, a stylus, or a microphone. The search engine 108 may include, without limitation, a broad-based search engine 110 or a domain-specific search engine 112. The domain-specific search engine 112, as distinct from the broad-based search engine 110, focuses on a specific segment of online content. The domain-specific content may be based on, without limitation, topicality, media type, or genre of content. Specific examples of such may include, but not be limited to, search engines designed specifically for legal topics, medical topics, travel topics, and the like.

The user query is sent over network(s) 104 to search engine server(s) 114. The search engine server(s) include, without limitation, a multitude of links to numerous (typically in the billions) web pages 116(1)-116(N), possible stored across thousands of machines. Web pages 116(1)-116(N) are searched to find pages that include the search terms included in the user query. To reduce the search results, a ranking-model module 118 ranks the web pages returned during the search according to their relevance with respect to the search terms input by the user. The ranking order is typically induced by, without limitation, giving a numerical score, an ordinal score, or a binary judgment such as “relevant” or “not relevant”. If the user query is performed using the broad-based search engine 110, a broad-based ranking-model module 120 uses a learning algorithm to reduce the search results to the most relevant pages, with respect to the search terms input by the user. Example learning algorithms include, without limitation, Classical BM25, Language Models for Information Retrieval, Ranking SVM, RankBoost, RankNet, and the like.

However, if the user query is performed using domain-specific search engine 112, a ranking-model adaptation module 122 enables the broad-based ranking-model module 120 to be modified into a domain-specific ranking-model module 124. The ranking-model adaptation module 122 includes, without limitation, a ranking adaptation support vector machines (SVM) module 126 and a ranking adaptability measurement module 128. Following the modification, the domain-specific ranking-model module 124 reduces the search results to the most relevant pages, with respect to the search terms input by the user into domain-specific search engine 112.

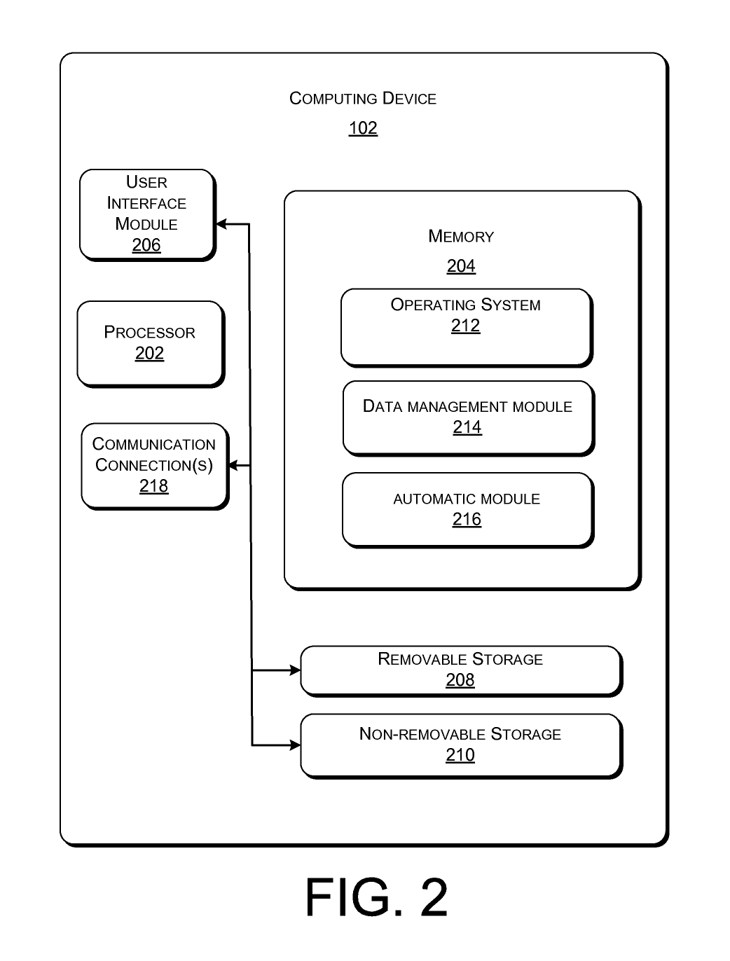

FIG. 2 illustrates an example computing device 102. The computing device 102 includes, without limitation, a processor 202, a memory 204, and one or more communication connections 206. An operating system 208, a user interface (UI) module 210, and a content storage 212 are maintained in memory 204 and executed on the processor 202. When executed on the processor 202, the operating system 208 and the UI module 210 collectively facilitate presentation of a user interface on a display of the computing device 102.

The communication connection 206 may include, without limitation, a wide area network (WAN) interface, a local area network interface (e.g., WiFi), a personal area network (e.g., Bluetooth) interface, and/or any other suitable communication interfaces to allow the computing device 102 to communicate over the network(s) 104.

The computing device 102, as described above, may be implemented in various types of systems or networks. For example, the computing device may be a stand-alone system, or may be a part of, without limitation, a client-server system, a peer-to-peer computer network, a distributed network, a local area network, a wide area network, a virtual private network, a storage area network, and the like.

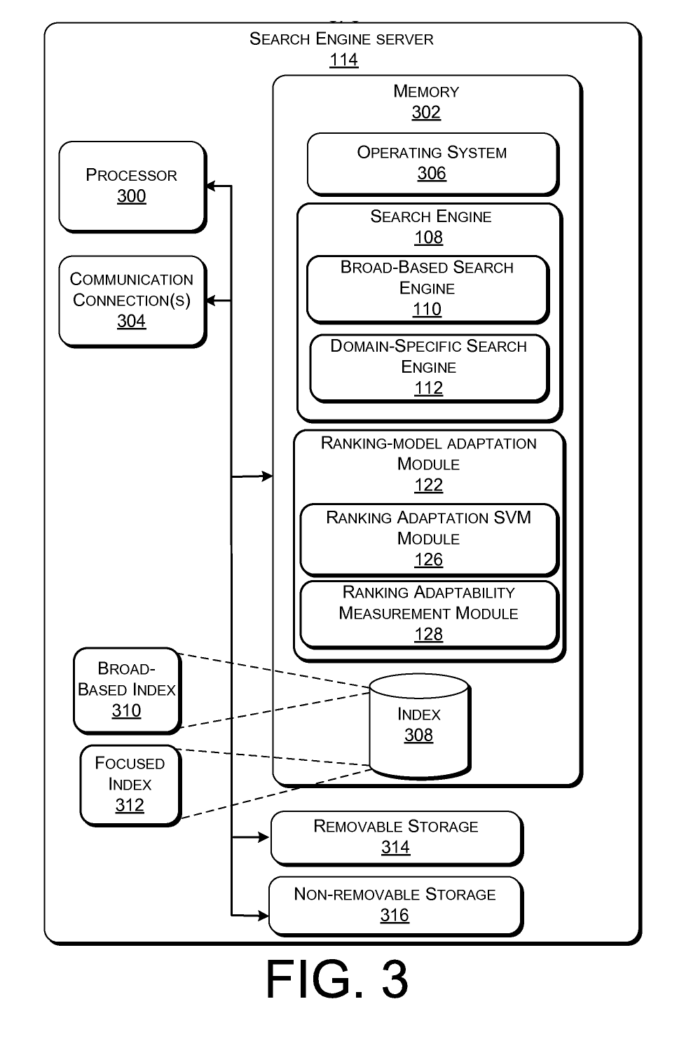

FIG. 3 illustrates an example search engine server 114. The search engine server 114 may be configured as any suitable system capable of services. In one example configuration, the search engine server 114 comprises at least one processor 300, a memory 302, and a communication connection(s) 304. The communication connection(s) 304 may include access to a wide area network (WAN) module, a local area network module (e.g., WiFi), a personal area network module (e.g., Bluetooth), and/or any other suitable communication modules to allow the web server 114 to communicate over the network(s) 104.

Turning to the contents of the memory 302 in more detail, the memory 302 may store an operating system 306, the search engine 108, the broad-based search engine 110, the domain-specific search engine 112, the ranking-model application module 120, the ranking adaptability measurement 122, the ranking adaptation SVM 124, and an index 308.

The index 308 includes, without limitation, a broad-based index 310 and a focused index 312. The broad-based index 310 may include, without limitation, links to multiple web pages related to a diverse portfolio of topics. The focused index 112 may include, without limitation, information pertaining to a specific topic, such as medical information. Therefore, there may be an infinite number of focused indices, where each focused index holds information relating to a specific topic. Alternatively, the focused index 112 may include one or more topics categorized for accessibility by a corresponding domain-specific search engine 112.

In one implementation, the index 308 fetches web pages 116(1)-116(N). After that the index 308 fetches the web pages that web pages 116(1)-116(N) are linked to, and so on, creating an index of as many web pages across the World Wide Web (hereinafter the “web”) as possible. The web pages 116(1)-116(N) are analyzed and indexed according to, without limitation, words extracted from a title of the web page, headings, special fields, topics, and the like. The index 308 may store all or part of the web pages 116(1)-116(N) or every word of the web pages 116(1)-116(N), enabling information to be returned to the user 106 as quickly as possible.

If the user 106 performs a general search using the broad-based search engine 110, the broad-based index 310 will be accessed to determine as many web pages as possible matching the search terms input by the user. However, if the user 106 utilizes the domain-specific search engine 112, looking for information pertaining to a specific topic, the domain-specific search engine 112 will access a corresponding focused index 312 in an attempt to search web pages that are relevant to the pre-defined topic or set of topics input by the user 106.

While the ranking-model adaptation module 122 and the search engine 108 are shown to be components within the search engine server 114, it is to be appreciated that the ranking-model adaptation module and the search engine 108 may alternatively be, without limitation, a component within the computing device 102 or a standalone component.

The search engine server 114 may also include additional removable storage 314 and/or non-removable storage 316. Any memory described herein may include volatile memory (such as RAM), nonvolatile memory, removable memory, and/or non-removable memory, implemented in any method or technology for storage of information, such as computer-readable instructions, data structures, applications, program modules, emails, and/or other content. Also, any of the processors described herein may include onboard memory in addition to or instead of the memory shown in the figures. The memory may include storage media such as, but not limited to, random access memory (RAM), read only memory (ROM), flash memory, optical storage, magnetic disk storage or other magnetic storage devices, or any other medium which can be used to store the desired information and which can be accessed by the respective systems and devices.

The server as described above may be implemented in various types of systems or networks. For example, the server may be part of, including but is not limited to, a client-server system, a peer-to-peer computer network, a distributed network, an enterprise architecture, a local area network, a wide area network, a virtual private network, a storage area network, and the like.

Various instructions, methods, techniques, applications, and modules described herein may be implemented as computer-executable instructions that are executable by one or more computers, servers, or computing devices. Generally, program modules include routines, programs, objects, components, data structures, etc. for performing particular tasks or implementing particular abstract data types. These program modules and the like may be executed as native code or may be downloaded and executed, such as in a virtual machine or other just-in-time compilation execution environment. The functionality of the program modules may be combined or distributed as desired in various implementations. An implementation of these modules and techniques may be stored on or transmitted across some form of computer-readable media.

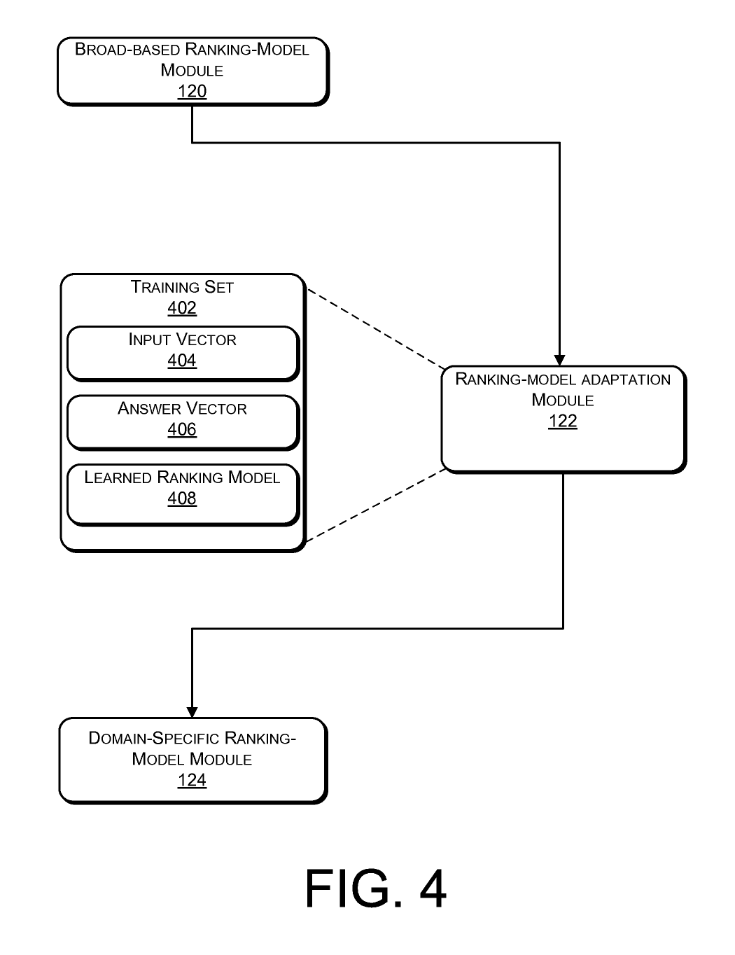

FIG. 4 illustrates an adaptation process 400 enabling an existing broad-based ranking-model module 120 to be adapted for use with a domain-specific ranking-model module 124.

In one implementation, the ranking-model adaptation module 122 utilizes a training set 402. The training set 402 consists of an input vector 404 and an answer vector 406 and is used in conjunction with a learning ranking model 408 to train the knowledge database within the target domain. For example, the input vector 404 may include a query set Q={q₁, q₂, . . . , qₘ} and a document set D={d₁, d₂, . . . d_{N}), whereby, the document set D may consist of training data for each query qᵢ ∈ Q. Utilizing the learning ranking model 408, the answer vector 406 may include a list of documents dᵢ={dᵢ₁, dᵢ₂, . . . , d_{i,n(q}_{₁}₎}, returned to the knowledge database and labeled with the relevance degrees yᵢ={yᵢ₁, yᵢ₂, . . . , y_{i,n(q}_{₁}₎} corresponding to a query qᵢ. In one implementation, the relevance degree is a real value, enabling different returned documents to be compared for sorting into an ordered list. For example, yij ∈ [symbol] . Alternatively, the relevance degree is any suitable value.

For each query document pair <qᵢ, dᵢⱼ>, an s-dimensional feature vector φ(qi,dij) ∈ [symbol] ^{s} is extracted. The number of returned documents of the query qᵢ is denoted as n(qᵢ). As described, the adaptation process 400 enables documents d to be ranked for the query q according to the value of the prediction ƒ(φ(q,d)) resulting in an estimated ranking function ƒ ∈ [symbol] ^{s}→ [symbol] .

In the example described above, both the number of queries m and the number of the returned documents n(qᵢ) in the training set are assumed to be small and might be insufficient to learn an effective ranking model for use with the domain-specific search engine 112, searching within a target domain. Therefore, additional knowledge may be used to efficiently and precisely adapt the broad-based ranking model module 120 to the domain-specific ranking-model module 124.

In one implementation, the adaptation process 400 may utilize an auxiliary ranking model ƒ^{a}, which is well trained in another domain over the labeled data Q^{a} and D^{a}, and that contains a great deal of prior knowledge within that other domain. Prior knowledge may be defined as all other information available in the other domain in addition to the training data. Therefore, the prior knowledge available from the auxiliary ranking model ƒ^{a} enables the small number of returned document and queries in the training set to be sufficient to perform the adaptation of the ranking model from the broad-based ranking model module 120 to the domain-specific ranking model module 124.

In one implementation, the ranking model utilized by the ranking-model adaptation module 122 may be a ranking support vector machines (SVM). The ranking SVM is generally used to cluster, classify, and rank data. Generally, the ranking SVM used by the broad-based search engine 110 enables the discovery of a one dimensional linear subspace, where query results may be ordered into an optimal ranking list based upon a given criteria. In one example, the ranking function of the ranking SVM may take the form of a linear model ƒ(φ(q,d))=w^{T}φ(q,d). The optimization for this example may be defined as:

$${min}_{f , {ξ}_{ijk}} \frac{1 }{2} {‖ f ‖}^{2} + C {\sum }_{i , j , k}^{ } {ξ}_{ijk} \\ s . t . f ( φ ( {q}_{i} , {d}_{ij} ) ) - f ( φ ( {q}_{i} , {d}_{ik} ) ) \geq 1 - {ξ}_{ijk} \\ {ξ}_{ijk} \geq 0 , \\ for ∀ i ∈ \{ 1 , 2 , … , M \} , \\ ∀ j ∀ k ∈ \{ 1 , 2 , … , n ( {q}_{i} ) \} with {y}_{ij} > {y}_{ik} \qquad Equation ( 1 )$$

where C is a trade-off parameter for balancing the large-margin regularization ∥ƒ∥2 and the loss term Σ_{i,j,k}ε_{i,j,k}. Because ƒ is a linear model, ƒ may be represented as ƒ(φ(qᵢ,dᵢ))−ƒ(φ(qᵢ,dᵢₖ))=ƒ(φ(qᵢ,dᵢⱼ)−φ(qᵢ,dᵢₖ)), with φ(qᵢ,dᵢⱼ))−φ(qᵢ,dᵢₖ) denoting the difference of the feature vectors between the document pair dᵢⱼ and dᵢₖ.

In one implementation, the conventional ranking SVM described with respect to equation (1) above may be adapted by the ranking adaptation module 122 for use with the domain-specific search engine 112. For example, the ranking-model adaptation module 122 utilizes a ranking adaptation support vector machines (SVM) module 126 to perform the adaptation.

In one implementation, to achieve the best possible adaptation, the ranking adaptation SVM module 126 assumes that the auxiliary domain and the target domain associated with the domain-specific search engine 112 are related, where their respective ranking functions are ƒ^{a} and ƒ, respectively, have similar shapes in a function space [symbol] ^{s}→ [symbol] . In this example, the ranking function for the auxiliary domain ranking function ƒ^{a} provides the prior knowledge necessary for the distribution of the target domain ranking function ƒ in its parameter space.

However, applying equation (1) to the domain-specific ranking model module 124 without modification may result in overfitting. In the process of overfitting, the performance of the training data sets increases, while the ability to predict the correct output for unknown data (unlabeled data) decreases. Therefore, the conventional ranking SVM needs to be adapted to better predict results for a user query within the domain-specific ranking model module 124.

To prevent overfitting, a conventional regularization framework may introduce additional information in or order to solve this problem. The regularization framework may approximate a variation principle containing both data (and documents) within the target domain and the prior knowledge from the auxiliary domain described above. Therefore, a conventional regularization framework may be adapted utilizing the prior knowledge of the auxiliary ranking model ƒ^{a} in the target domain where only a few query document pairs have been labeled within the target domain. Based upon this assumption within the regularization framework, the ranking adaptation SVM module 126 can adapt the conventional ranking SVM described in equation (1) above to:

$${min}_{f , {ξ}_{ijk}} \frac{1 - δ }{2} {‖ f ‖}^{2} + \frac{δ}{2} {‖ f - {f}^{α} ‖}^{2} + C {\sum }_{i , j , k}^{ } {ξ}_{ijk} \\ s . t . f ( φ ( {q}_{i} , {d}_{ij} ) ) - f ( φ ( {q}_{i} , {d}_{ik} ) ) \geq 1 - {ξ}_{ijk} \\ {ξ}_{ijk} \geq 0 , \\ for ∀ i ∈ \{ 1 , 2 , … , M \} , \\ ∀ j ∀ k ∈ \{ 1 , 2 , … , n ( {q}_{i} ) \} with {y}_{ij} > {y}_{ik} . \qquad Equation ( 2 )$$

The objection function of equation (2) consists of an adaptation regularization term ∥ƒ−ƒ^{a}∥², minimizing the distance between the ranking function ƒ in the target domain and the ranking function ƒ^{a} in the auxiliary domain. Equation (2) also consists of a large-margin regularization term ∥ƒ∥² and a loss term Σ_{i,j,k}εᵢⱼₖ. The parameter δ ∈ [0,1] is a trade-off term to balance the contributions of large-margin regularization ∥ƒ∥² which makes the learned ranking model within the domain-specific environment numerically stable, and adaptation regularization ∥ƒ−ƒ^{a}∥² which makes the learned ranking model within the domain-specific environment similar to the auxiliary one. When δ=0, Equation (2) degrades to the conventional ranking SVM of Equation (1). For example, Equation (2) is equivalent to the ranking SVM for the auxiliary domain, resulting in overfitting if used to predict results in the target domain.

The parameter C in equation (2) balances the contributions between the loss function and the regularization terms. In one implementation, when C=0 and δ=1, equation (2) discards the labeled samples in the target domain and directly outputs a ranking function with ƒ=ƒ^{a}. Such a scenario may be desirable if the labeled training samples in the auxiliary domain are unavailable or unusable. In such a scenario, ƒ^{a} is believed to be better than a random guess for ranking the documents (or web pages) in the target domain (assuming that the auxiliary domain and the target domain are related).

To optimize equation (2), a term xiⱼₖ=φ(qᵢ,dᵢⱼ−φ(qᵢ,dᵢₖ) is introduced. In addition to this term, Lagrange multipliers are also introduced to integrate constraints into the objective function of equation (2), resulting in:

$${L}_{P} = \frac{1 - δ }{2} {‖ f ‖}^{2} + \frac{δ}{2} {‖ f - {f}^{α} ‖}^{2} + C {\sum }_{i , j , k}^{ } {ξ}_{ijk} - {\sum }_{i , j , k}^{ } {μ}_{ijk} {ξ}_{ijk} - {\sum }_{i , j , k}^{ } {α}_{ijk} ( f ( {x}_{ijk} ) - 1 + {ξ}_{ijk} ) ) \qquad Equation ( 3 )$$

Taking the derivatives of Lₚ w.r.t. ƒ, and setting it to zero, the following solution is obtained:

ƒ(x)=δƒ^{a}(x)+Σ_{i,j,k}αᵢⱼₖxᵢⱼₖ^{T}x Equation (4)

Denoting Δƒ(x)=Σᵢⱼₖαᵢⱼₖxᵢⱼₖ^{T}x, it may be derived from equation (4) that the final ranking function ƒ for the target domain is a linear combination between the auxiliary function ƒ^{a} and Δƒ, where the parameter δ controls the contribution of ƒ^{a}.

In addition to integrating the constraints of equation (4), the optimal solution of equation (2) should satisfy the Karush-Kuhn-Tucker (KKT) conditions. The KKT conditions consist of:

αᵢⱼₖ(ƒ(xᵢⱼₖ)−1+ξᵢⱼₖ)=0

αᵢⱼₖ≧0

ƒ(xᵢⱼₖ)−1+ξᵢⱼₖ≧0

μᵢⱼₖξᵢⱼₖ=0

μᵢⱼₖ≧0

ξᵢⱼₖ≧0

C−αᵢⱼₖ−μᵢⱼₖ=0. Equation (5)

Substituting equations (4) and (5) into equation (3), the formulation may be derived as:

$${max}_{{α}_{ijk}} - \frac{1}{2} {\sum }_{i , j , k}^{ } {\sum }_{l , m , n}^{ } {α}_{ijk} {α}_{lmn} {x}_{ijk} {x}_{lmn} + {\sum }_{i , j , k}^{ } ( 1 - δ f ( {x}_{ijk} ) ) {α}_{ijk} \\ s . t . 0 \leq {α}_{ijk} \leq C , \\ for ∀ i \{ 1 , 2 , … , M \} , \\ ∀ j ∀ k ∈ \{ 1 , 2 , … , n ( {q}_{i} ) \} with {y}_{ij} > {y}_{ik} . \qquad Equation ( 6 )$$

Equation (6) is a standard quadratic programming (QP) problem and a standard QP solver may be utilized to solve it.

Utilizing the ranking adaptation SVM module 126 to obtain an adapted ranking SVM, for example equations (1)-(6), introduces several advantages when ranking results within the domain-specific search engine 112. One example is the use of model adaptation versus that of data adaptation. For example, the adapted ranking SVM defined in equations (1)-(6) does not require the labeled training samples from the auxiliary domain. Instead, equations (1)-(6) only require the ranking function model ƒ^{a}. Using the ranking function model ƒ^{a} may circumvent the problem of missing training data from within the auxiliary domain, as well as copyright or privacy issues.

Another advantage of utilizing the adapted ranking SVM defined in equations (1)-(6) may be what is referred to as the black-box adaptation. For example, to obtain the ranking adaptation SVM, the internal representation of the model ƒ^{a} is not needed. Only the prediction of the auxiliary model is used in conjunction with the training samples of the target domain. Utilizing the black-box adaptation eliminates the necessity to know what learning model (algorithm) the auxiliary domain is using to predict results. Again, only the ranking function model ƒ^{a} predictions are necessary.

Another advantage lies in the need to utilize very few labeled training samples within the target domain, thereby reducing the labeling costs. By adapting the auxiliary ranking model to the target domain, only a small number of samples need to be labeled. Equation (2), set forth above, addresses the lack of labeled training samples utilizing the regularization term ∥ƒ−ƒ^{a}∥².

Furthermore, utilizing the ranking adaptation SVM reduces overall computational costs. For example, as discussed above with respect to equation (6), the adapted ranking model may be transformed into a Quadratic Programming (AP) problem, with the learning complexity directly related to the number of labeled samples in the target domain.

While specific advantages are discussed above, it is to be appreciated that the advantage of utilizing the ranking adaptation SVM module 126 may be numerous and are not limited to those examples discussed above,

The adapted ranking SVM defined in equations (1)-(6) may be extended to a more general setting, where ranking models learned from multiple auxiliary domains are provided. For example, in one implementation, denoting the set of auxiliary ranking functions as F={ƒ₁^{a}, ƒ₂^{a}, . . . ƒ_{R}^{a}}, adapting the ranking-SVM for multiple domain is formulated as:

$${min}_{f , {ξ}_{ijk}} \frac{1 - δ }{2} {‖ f ‖}^{2} + \frac{δ}{2} {\sum }_{r = 1}^{R} {θ}_{r} {‖ f - {f}_{r}^{α} ‖}^{2} + C {\sum }_{i , j , k}^{ } {ξ}_{ijk} \\ s . t . f ( φ ( {q}_{i} , {d}_{ij} ) ) - f ( φ ( {q}_{i} , {d}_{ik} ) ) \geq 1 - {ξ}_{ijk} \\ {ξ}_{ijk} \geq 0 , \\ for ∀ i ∈ \{ 1 , 2 , … , M \} , \\ ∀ j ∀ k ∈ \{ 1 , 2 , … , n ( {q}_{i} ) \} with {y}_{ij} > {y}_{ik} , \qquad Equation ( 7 )$$

where θᵣ is the parameter that controls the contribution of the ranking model ƒᵣ^{a} obtained from the r^{th} auxiliary domain. Similar to the analysis of the one domain adaptation setting discussed above, the solution for equation (7) may be defined as:

ƒ(x)=δΣᵣ₌₁^{R}θᵣƒᵣ^{a}(x)+Σ_{i,j,k}αᵢⱼₖxᵢⱼₖ^{T}x Equation (8)

If ƒ^{a}(x)=Σᵣ₌₁^{R}θᵣƒᵣ^{a}(x), the auxiliary ranking functions can be represented as a single function, which may lie in the convex hull of F. Thus, similar to the discussion with respect to equation (4), the adapted ranking model is a linear combination of two parts, i.e., the convex combination of ranking functions from auxiliary domains ƒ^{a}, and the part from the target set Δƒ=Σ_{i,j,k}αᵢⱼₖxᵢⱼₖ^{T}x, with the parameter θᵣ controlling the contribution of the auxiliary model ƒᵣ^{a}, while δ controls all the contributions from F globally.

Though the ranking adaptation mostly provides benefits for learning a new ranking model for a target domain, it may be argued that when the data from the auxiliary domain and the target domains share little common knowledge, for example, the two domains are not related, the auxiliary ranking model may provide little to no advantage when adapting for use with the target domain. It is therefore necessary to develop a measure for quantitatively estimating the adaptability of the ranking model used in the auxiliary domain for use within the target domain. To determine the adaptability, an analysis of the properties of the auxiliary ranking model ƒ^{a} is necessary.

In one implementation, the auxiliary model may be analyzed using the loss constraint present in equation (2) above. For example, by substituting equation (4) into equation (2), the analysis may be defined by:

δƒ^{a}(xᵢⱼₖ)+Δƒ(xᵢⱼₖ)≧1−ξᵢⱼₖ with yᵢⱼ>yᵢₖ, and ξᵢⱼₖ≧0, Equation (9)

where, as defined above, xijk=φ(qᵢ,dᵢⱼ)−φ(qᵢ,dᵢₖ) and Δƒ=Σ_{i,j,k}αᵢⱼₖxᵢⱼₖ^{T}x. Thus, in order to minimize the ranking error ξᵢⱼₖ for the document pair dᵢⱼ and dᵢₖ, a high prediction value on the left-hand side of the first inequation in equation (9) is desired.

For a given auxiliary ranking function ƒ^{a}, a comparatively large ƒ^{a}(xᵢⱼₖ) suggests that ƒ^{a} may correctly judge the order for the document pair dᵢⱼ and dᵢₖ, and vice versa. Therefore, according the constraints of equation (9), if ƒ^{a} is capable of predicting the order of the documents correctly, the contribution of the part of the ranking function in the target domain, i.e., Δƒ, may be relaxed. If ƒ^{a} is able to predict all pairs of documents correctly in the target domain, for example a perfect ranking list for all of the labeled queries, ƒ^{a} should be adapted to the target domain directly without any necessary modifications. However, if ƒ^{a} is unable to give a desirable ordering of the document pairs, Δƒ will need to be leveraged with a high contribution to eliminate the side effects of ƒ^{a} to enable the ranking error over the labeled samples to be reduced. Consequently, the performance of ƒ^{a} over the labeled document pairs in the target domain greatly affects the ability to adapt the auxiliary ranking model ƒ^{a}.

The ranking adaptability measurement module 128 quantitatively estimates if an existing auxiliary ranking model used within the broad-based ranking-model module 120 may be adapted by the ranking-model adaptation module 122 to the domain-specific ranking-model module 235 for use with a target domain.

In one implementation, the ranking adaptability measurement module 128 investigates the correlation between two ranking lists of the labeled documents in the target domain, i.e., the one predicted by ƒ^{a} and those labeled by human annotators. If the two ranking lists have a high positive correlation, the auxiliary ranking model ƒ^{a} is coincided with the distribution of the corresponding labeled data, and it may therefore be concluded that the auxiliary ranking model ƒ^{a} possesses a high ranking adaptability towards the target domain.

In one implementation, Kendall's τ, known in the art, may be used to calculate the correlation between the two ranking lists. For a given query qᵢ, a rank list predicted by the ranking function ƒ may be denoted as y*ᵢ={y*ᵢ₁, y*ᵢ₂, . . . y*_{i,n(q}_{ᵢ}₎}, and define a pair of documents (dᵢⱼ,yᵢⱼ) and (dᵢₖ,yᵢₖ) as concordant if (yᵢⱼ−yᵢₖ)(y*ᵢⱼ−y*ᵢₖ) [symbol] 0, and discordant if (yᵢⱼ−yᵢₖ)(y*ᵢⱼ−y*ᵢₖ) [symbol] 0. Furthermore, the number of concordant pairs may be denoted as Nᵢ^{c}=Σⱼ₌₁^{n(q}^{ᵢ}⁾Σₖ₌ⱼ₊₁^{n(q}^{ᵢ}⁾sign[(y*ᵢⱼ−y*ᵢₖ)(yᵢⱼ−yᵢₖ) [symbol] 0] and the number of discordant pairs as Nᵢ^{c}=Σⱼ₌₁^{n(q}^{ᵢ}⁾Σₖ₌ⱼ₊₁^{n(q}^{ᵢ}⁾sign[(y*ᵢⱼ−y*ᵢₖ)(yᵢⱼ−yᵢₖ) [symbol] 0], where sign (x) is the sign function with sign (x)=1 if x>0, sign (x)=−1 if x<0, and sign(x)=0 otherwise.

In one example, suppose qᵢ has neither tied prediction, i.e., for ∀j∀ky*ᵢⱼ≠y*ᵢₖ nor tied relevance (i.e., for ∀j∀kyᵢⱼ≠yᵢₖ), then Nᵢ^{c}+Nᵢ^{d}=n(qᵢ)(n(qᵢ)−1)/2. In such a situation where no ties exist, the rank correlation for function ƒ over the query q, based on the Kendall's τ, may be defined as:

$${T}_{i} ( f ) = \frac{{N}_{i}^{c} - {N}_{i}^{d}}{n ( {q}_{i} ) ( n ( {q}_{i} ) - 1 ) / 2} \qquad Equation ( 10 )$$

However, ties are rather common for general application in a web search environment. Therefore, when ties do exist, the ties may be managed by adding 0.5 to Nᵢ^{c} and 0.5 to Nᵢ^{d} if yᵢⱼ=yᵢₖ, and ignore the pairs with y*ᵢⱼ=y*ᵢₖ. Therefore, a more general definition for the correlation is

$${T}_{i} ( f ) = \frac{{N}_{i}^{c} - {N}_{i}^{d}}{{N}_{i}^{c} + {N}_{i}^{d}} \qquad Equation ( 11 )$$

Based upon equation (11), the ranking adaptability of the auxiliary ranking model ƒ^{a} for the target domain is defined as the mean of the Kendall's τ correlation between the predicted rank list and the perfect rank list, for all the labeled queries in the target domain. Therefore, the ranking adaptability may be defined as:

$$A ( {f}^{a} ) = \frac{1}{M} {\sum }_{i = 1}^{M} {T}_{i} ( {f}^{a} ) \qquad Equation ( 12 )$$

The ranking adaptability, as defined in equation 12, measures the rank correlation between the ranking list sorted by the auxiliary model prediction and the ground truth rankings performed by human annotators. Such a measurement indicates whether the auxiliary ranking model ƒ^{a} may be adapted for use with the target domain.

Alternatively, an automatic model selection may be performed to determine which auxiliary model will be adapted for use with the target domain.

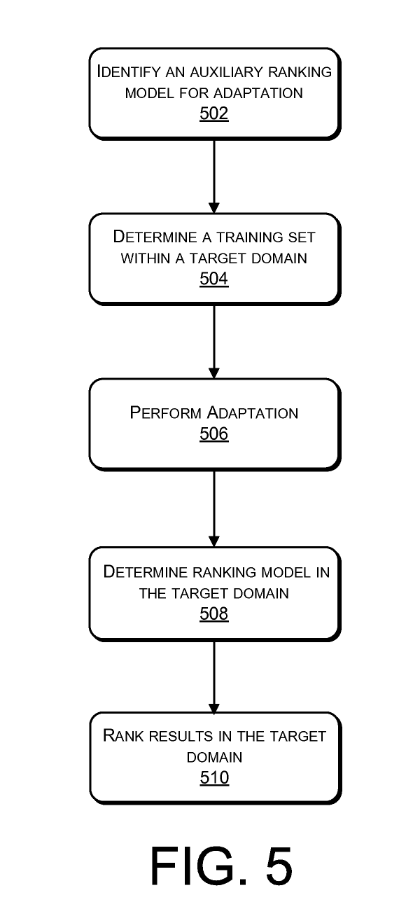

FIG. 5 illustrates an example process 500 outlining the adaptation process for a ranking model set forth above. In the flow diagram, the operations are summarized in individual blocks. The operations may be performed in hardware, or as processor-executable instructions (software or firmware) that may be executed by one or more processors. Further, the process 500 may, but need not necessarily, be implemented using the framework of FIG. 1.

At block 502, an auxiliary ranking model for adaptation is identified by the ranking adaptability measurement module 128. At block 504, a training set for the target domain is determined. For example, the training set may be comprised of an input vector consisting of a query set and a document set (or web page such as web page(s) 116(1)-116(N)) and an answer vector consisting of ranking results.

At block 506, the adaptation process described above with respect to equations (1)-(6) is performed. At block 508, utilizing the determined training set for the target domain in conjunction with the prior knowledge from the auxiliary domain, a ranking model is ascertained for use with the domain-specific ranking-model module 124. In one example, a standard quadratic programming (QP) problem and a standard QP solver may be utilized to make the determination.

At block 510, results corresponding to a user query entered into the domain-specific search engine 112 may be ranked according to their correlation to the search terms input by the user.

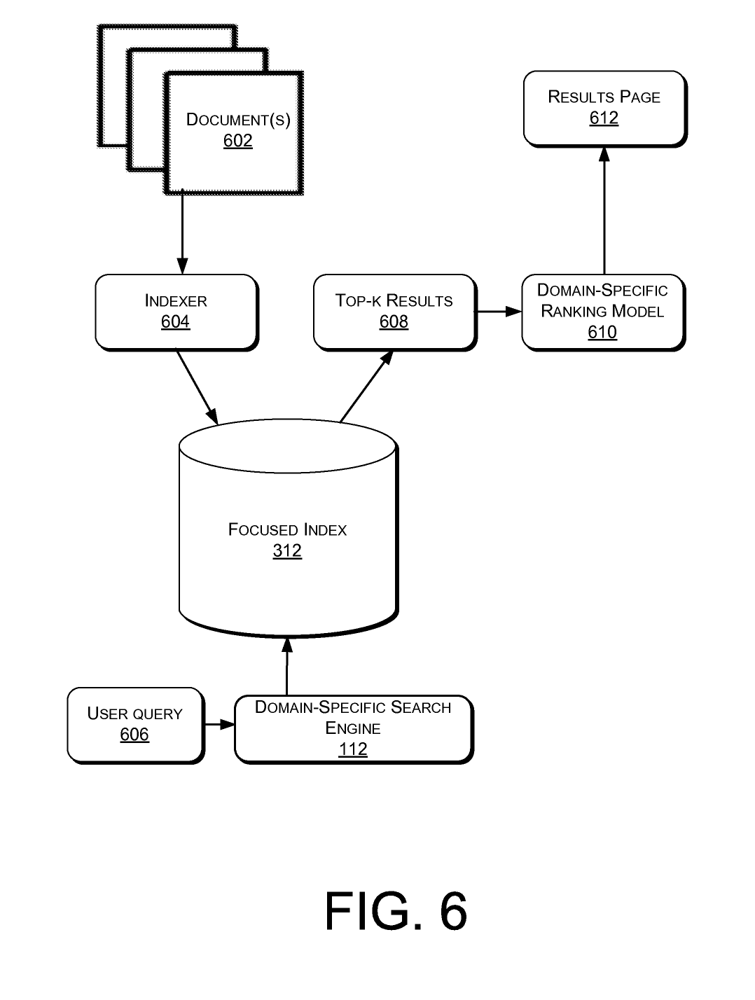

FIG. 6 illustrates an example process 600 of conducting a domain-specific search as set forth above. In this example, one or more documents 602 are fetched by indexer 604 for storage by the focused index 312. In one implementation, the document(s) 602 include web pages 116(1)-116(N). The web pages 116(1)-116(N) pertain to a specific topic, such as, without limitation, travel, medicine, etc.

The user 106 may then input a user query 606 into the domain-specific search engine 112 via computing device 102. In response, the focused index 312 retrieves the top-k results 608 corresponding to the user query 606.

The domain specific ranking model 610 ranks the results, with those results having the highest correlation to the user query being uppermost on results page 612 or otherwise being output in a more prominent manner. The results page 612 is presented to the user 106 on computing device 102

### Conclusion

Although an indication process to adapt a ranking-model constructed for a broad-based search engine for use with a domain-specific ranking-model has been described in language specific to structural features and/or methods, it is to be understood that the subject of the appended claims are not necessarily limited to the specific features or methods described. Rather, the specific features and methods are disclosed as example implementations.

What is claimed is:

1. A computer-implemented method comprising:
identifying a ranking model utilized by a first domain;
performing an adaptation process to transform the ranking model utilized by the first domain for use with a second domain, the adaptation process resulting in an adapted ranking model and comprising:
introducing a regularization framework to the ranking model to approximate a variation principle comprising at least data within the second domain and a prior knowledge from the first domain; and
conducting a search within the second domain to identify search results associated with the search; and
ranking the search results obtained using the adapted ranking-model.

2. The method of claim 1, wherein the adaptation process utilizes one or more predictions obtained from the ranking model to determine the adapted ranking model.

3. The method of claim 1, wherein the first domain comprises general content.

4. The method of claim 1, wherein the second domain comprises domain-specific content.

5. The method of claim 1, wherein the first domain comprises more than one domain.

6. The method of claim 1 further comprising determining a training set for the second domain, the training set comprising (1) an input vector comprising a query set and a document set of one or more web pages, and (2) an answer vector comprising one or more ranking results.

7. The method of claim 1, wherein the identifying comprises determining a correlation between a first predicted ranking list of one or more labeled documents in the second domain and a second ranking list of the one or more labeled documents in the second domain, wherein the second ranking list is determined by a human annotator.

8. The method of claim 1, wherein the first domain and the second domain are related.

9. The method of claim 1, wherein the search is based on a query, and wherein the adaptation process enables one or more documents to be ranked corresponding to the query according to the value of a prediction within the second domain, resulting in an estimated ranking function for the second domain.

10. A system comprising:
a memory;
one or more processor coupled to the memory;
a ranking-model adaptation module operable on the one or more processors and comprising:
a ranking adaptation support vector machines (SVM) module enabling an adaptation process to transform a first ranking model to a second ranking model;
a ranking adaptability measurement module to quantitatively estimate an adaptability of the first ranking model; and
a quadratic program solver utilized to solve a quadratic optimization problem determined by the ranking-model adaptation module.

11. The system of claim 10 further comprising an index comprising:
a general index utilized in conjunction with a general search engine to determine one or more web pages within the general index corresponding to a general search; and
a focused index utilized in conjunction with a domain-specific search engine to determine one or more relevant web pages within a pre-defined topic.

12. The system of claim 10, further comprising a training set comprising an input vector and an answer vector; the input vector comprising a query set Q={q₁, q₂, . . . , qₘ} and a document set D={d₁, d₂, . . . d_{N}), and wherein the document set D may consist of training data for each query q₁ ∈ Q, and the answer vector comprises a list of documents dᵢ={dᵢ₁, dᵢ₂, . . . , d_{i,n(q}_{₁}₎}.

13. The system of claim 12, wherein the answer vector further comprise one or more relevance degrees yᵢ={yᵢ₁, yᵢ₂, . . . , y_{i,n(qi)}} corresponding to the query qᵢ, wherein the relevance degree is a real value, enabling different returned documents to be compared for sorting into an ordered list.

14. The system of claim 10, wherein the first ranking model is utilized by a general domain and the second ranking model is utilized by a specific domain.

15. The system of claim 14, wherein the quantitative estimate is determined based upon a correlation between a first predicted ranking list in the specific domain and a second ranking list in the specific domain.

16. The system of claim 15, wherein the general domain comprises web pages corresponding to more than one online content area and the specific domain corresponds to a specific segment of online content.

17. The system of claim 15, wherein the ranking adaptability of the ranking model for the specific domain is defined as the mean of a Kendall's τ correlation between a predicted rank list and a perfect list for one or more labeled queries in the specific domain.

18. One or more computer-readable devices storing computer-executable instructions that, when executed on one or more processors, cause the one or more processors to perform an operation comprising:
performing an adaptation process to transform a ranking model utilized by a general domain for use with a specific domain, the adaptation process enabling one or more web pages corresponding to a search query to be ranked resulting in an estimated ranking function for the specific domain.

19. The computer-readable devices of claim 18, further comprising estimating an adaptability of a ranking model utilized by the general domain for use with the specific domain.

20. The computer-readable devices of claim 18, wherein the adaptation process utilizes a training set within the specific domain in conjunction with prior knowledge from the general domain to ascertain an adapted ranking model.
